(19) United States
(12) Patent Application Publication
(10) Pub. No.: US 2004/0034593 A1
(43) Pub. Date: Feb. 19, 2004

(54) Electronic business monitoring system

(76) Inventors: Steve Toneguzzo, Sydney (AU); Aftab Rizvi, Sydney (AU)

Correspondence Address: SPECKMAN LAW GROUP, 1501 WESTERN AVE, SUITE 100, SEATTLE, WA, 98101, US

(21) Appl. No.: 10/362,956

(22) PCT Filed: Aug. 27, 2001
(86) PCT No.: PCT/AU01/01064

(30) Foreign Application Priority Data
Aug. 25, 2000 (AU) PQ 9691

(51) Int. Cl. G06F 17/60

(52) U.S. Cl. 705/39; 705/35; 705/31

(57) ABSTRACT

Methods and software are disclosed which relate to the remote monitoring of networked electronic business. Businesses may be monitored for the purpose of confirming compliance with tax or other legal regulations. The invention provides an application interface which cooperates with a monitoring agency, preferably within a public lay infrastructure.

### TECHNICAL FIELD

The present invention pertains to the monitoring of electronic commerce data and systems (meaning operating software, application software and system configurations) for the purpose of monitoring compliance with tax and other legal regulations as well as the thwarting of tax evasion and other illegal conduct.

### BACKGROUND ART

Treasuries around the world are struggling with the question of how to maintain control of fiscal policy and attend, in the advent of wide spread electronic commerce, to the elimination of tax evasion and money laundering in a globally networked environment.

### DISCLOSURE OF THE INVENTION

Among the objects of the invention are to provide an electronic business monitoring method, apparatus and software having some combination of the following features:

(a) The ability to identify a corporation's or individual's electronic commerce activity through an electronic business identity.

(b) A hierarchal administration (analogous to a PKI system).

(c) Internal Controls adopted by the hierarchal administrators (analogous to a Certificate Practice Statement).

(d) An approved system of Internal Controls for the e-business provider.

(e) A central monitoring system.

(f) Definition of one or more standard interfaces.

(g) An Application Interface (API) or dedicated program to perform the interface.

In one embodiment of the invention, one or more e-commerce software products or applications are provided. These plug-ins are installed into or required to be installed into an e-commerce system operated by a business. The plug-in preferably operates within a secure environment and provides identification information and other forms of data to a central computer system that may be controlled by an independent agency, treasury, taxation office or other appropriate regulatory body at a state, federal or international level.

In preferred examples of the invention, functions that could be performed include the detection of suspicious transactions, financial reporting, notification of revenue streams according to which tax jurisdiction the revenue originates from, secure remote verification of installed operating, application or plug-in software and/or configuration to provide assurance of the integrity of the systems and software or indeed the validity of software licenses.

### BRIEF DESCRIPTION OF THE DRAWINGS

FIG. 1 is a schematic diagram illustrating an operation of the method, software and apparatus of the present invention.

### MODES FOR CARRYING OUT THE INVENTION

In order to levy a tax or monitor the accrual of tax obligations or for other purposes a government or its agency or a private agency must assess the transactions conducted at an e-commerce site.

Rather than rely on manual or conventional reporting procedures, the present invention proposes a means whereby the required data is provided, acquired and analysed automatically.

Electronic Business Identity

The first requirement for such a system is the issuance of secure and reliable electronic business identities. An appropriate identity for business-to-business transactions is a digital certificate or optionally, a proprietary digital certificate of the type discussed in the applicant's co-pending Australian provisional patent specification, Serial No. PQ 8657. An appropriate electronic identity for consumer to business transactions could be a digital signature or digital certificate or either of these for example, one incorporating biometric data as explained in the applicant's co-pending Australian provisional patent specification (PQ 9692) which has been lodged concurrently with the present specification. Both of these documents are incorporated herein by reference.

Given the means by which businesses and individuals may be securely and reliably identified electronically, the present invention preferably requires the implementation of a Public Key Infrastructure (PKI).

A Public Key Infrastructure is a combination of hardware and software products, policies and procedures. A PKI is based on the issuance and management of digital IDs known as “digital certificates” which act like electronic passports.

A Hierarchal Administration

Within the context of the present invention, the certification authority (“CA”) may be a government or an independent agency contracted by one or more governments or agencies. Where different governments or jurisdictions abide by the same CA, or according to a common certificate practice statement (CPS) data may be exchanged between those governments or jurisdictions with considerable confidence, for example where two countries have a tax-sharing arrangement such that a proportion of monies taxed by country A, on trade with residents of country B, are remitted back to country A. The remittance concept may also apply at a state or a local level.

An example of a simple hierarchy may be: A global agency (analogous to a root CA) is responsible for administering international taxation and law enforcement arrangements and a national agency (analogous to a CA) is responsible for administering national taxation and law enforcement arrangements. An RA or regional agency (analogous to RA) may be responsible for administering State taxation and law enforcement arrangements.

Internal Controls Adopted by the Hierarchical Administrators

Associated with monitoring administration and the possible hierarchy of the monitoring administrators is an Administrative Internal Control Manual (AICM) defining the operation, security and regulatory requirements and guidelines the administration must comply with in order to participate in electronic monitoring. The AICM may address the following areas:

(a) The issuance or association of an electronic business identity with an electronic business.

(b) e-Business compliance requirements.

(c) Roles, responsibilities and interrelationships of the various levels of Monitoring Administrators (MA) and third parties in the hierarchy.

(d) Roles, responsibilities and interrelationships of the Root Monitoring Administrator (RMA).

(e) PKI Infrastructure.

(f) Organisational relationships.

(g) Public policy and legislative matters.

(h) Standard operating internal controls and procedures for RMA's and MA's.

(i) Definition of classification and related criteria.

(j) Security classifications.

(k) Codes of conduct.

(l) Fees and charges.

(m) List of acceptable bona-fides for all stakeholders.

(n) Application for certificate.

(o) Auditing prior to application.

(p) Ongoing auditing.

(q) Terms and conditions.

(r) Generation and security of digital certificate

(s) Generation and security of compliance seal.

(t) Rules of use.

(u) Delivery of digital certificate and seal.

(v) Revocation of digital certificate and seal.

(w) Distribution and usage of revocation and attribute tables.

(x) Frequently asked questions.

(y) User help.

(z) Complaints mechanisms.

(aa) Metrics and statistical analysis.

(bb) Distribution, installation, operation and security of API and related software and hardware.

(cc) General information.

(dd) Enforcement mechanisms and penalties.

(ee) Any other applicable information.

Internal Controls for the e-Business Provider

Associated with the interface to the monitoring system is a Business Internal Controls Manual (BICM) defining the operation, security and regulatory interface requirements and guidelines the electronic business must comply with in order to participate in electronic monitoring. The BICM will address the following areas at a minimum:

(a) Minimum interface requirements for the API (e-commerce system application interface).

(b) Security policy and procedures for the API.

(c) Operating procedures for the plug-in.

(d) Escalation procedures.

(e) External audit.

(f) Delivery of the API.

(g) Installation of the API.

(h) Help Procedures.

(i) FAQ's.

(j) Software Change Controls.

(k) Configuration of the API.

(l) Disaster Recovery.

(m) System Testing and Validation.

(n) Fault Reporting.

(o) Version Updates and Emergency Patches.

(p) Software and Configuration Monitoring.

(q) Privacy policy.

(r) User manual.

Application Interface

An important aspect of the present invention is the application interface (API) plug-in, or dedicated programme, which interfaces with or is embedded into an e-commerce system and facilitates the regulatory and audit functions associated with the present invention. The API essentially captures and processes data associated with the operation of the e-commerce site and compiles the data into a form, which may be exported over an electronic network or dedicated service to one or more monitoring systems. The API is able to capture the required data either by interrogating the e-commerce system or obtaining exported data or otherwise. Another method of data capture is to configure the e-commerce system to compile a table into which the appropriate data is exported. The API of the present invention must be secure and may have the following functionality at a minimum:

(a) Application or operating system software verification to ensure that approved (designated) programmes have not been modified without the regulator's consent.

(b) Monitoring of the software applications and operating systems associated with the e-commerce site.

(c) Monitoring, capture and transmission of the nominated data in one or more prescribed formats.

(d) Monitoring, capture and transmission of nominated transactions.

(e) Comparison of data or transactions against a set of rules and the consequent determination of exceptions to those rules. This may be a direct comparison or knowledge based expert system. For example, comparing the financial transactions against legislative guidelines for suspicious financial transactions.

(f) Reporting of exceptions or nominated financial data to the one or more monitoring systems which may monitor a given business.

(a) Ensure software licences are current.

Monitoring System

In order to support and provide maximum utility of the API, one or more monitoring systems are required. A central monitoring system is one which monitors many other systems or business systems in a given jurisdiction. The one or more monitoring systems of the present invention are capable of either receiving data from the various APIs or interrogating the APIs for their data. The central monitoring system may be operated by a government or jurisdiction or may be run privately under contract to a government or jurisdiction. A monitoring system according to the teachings of the present invention may have some or all the following functionality:

(a) Configurable in accordance with defined rules.

(b) Remote monitoring of an electronic business.

(c) Remote monitoring of a monitoring system (which may itself be an electronic business).

(d) Remote monitoring of API integrity.

(e) Remote monitoring of nominated electronic business software applications and operating system integrity and authenticity.

(f) Remote monitoring or capture of nominated data.

(g) Remote monitoring or capture of nominated transactions.

(h) Comparison of captured data or transactions against a set of rules and determination of exceptions. This may be a direct comparison or knowledge based expert system. For example, comparing the financial transactions against legislative guidelines for suspicious transactions.

(i) Reporting of exceptions for example irregularities such as suspicious transactions, likely tax evasion etc to nominated financial institutions or governments, as required. The report may be in the form of an alert generated upon detection of an irregularity.

(j) Reporting of exceptions over the network to affiliates in the monitoring system.

(k) Initiation of electronic funds transfers for taxation or tax remittance purposes.

(l) Reporting of exceptions or nominated financial data at the local systems.

It will be appreciated that the monitoring system of the present invention may in fact comprise a hierarchy of monitoring systems that provide for distributed processing in analysis, control and data security. A hierarchal structure can be customised according to the particular legislative or jurisdiction requirements. For example, there may be a hierarchy of state, federal and international monitoring systems, which exchange data and/or reports in accordance with pre-established guidelines.

API Interface

In preferred embodiments of the invention the API plug-in provides for a standard interface. For example, provisions are made for the definition of data-files required to be provided or maintained by the electronic business' systems (EBS). Ultimately the API 20 must provide a reply to the requirements of the monitoring agencies 30, 31. This may be done through scheduled sends from the API or through data requests sent from the agency over the network to the API. Similarly the API may acquire its data from an EBS by interrogating it or by obtaining sends from the EBS. Typical data, which might be accessed by the API, includes:

(a) The business ID.

(b) Customer ID.

(c) Location of business.

(d) Location of customer.

(e) Description of product or service provided.

(f) Cost of product or service provided.

(g) Additional taxation information.

(h) Revenue information.

The software, methods and apparatus of the present invention also provide for an audit mechanism, which is capable of reconciling financial data from the electronic business with the financial records of a bank, credit card issuing authority or other financial institution. This allows the monitoring agencies or external auditors unprecedented power to detect improper conduct.

As the system of the present invention requires the appendage of a digital certificate to all on-line electronic commerce content, this same digital certificate may be used to attach a financial charge to the delivery of the chargeable on-line content to a user (where the user is identified with either a business digital certificate or natural person digital signature or established account number). The charges accruing to an individual or business may be tracked by the monitoring system of the present invention. At the time when a request is made the requesting party may be identified by way of the “cookie” provided by the requesting party.

In the alternative, appended to the cookie may be an amount of value in electronic currency. For example, a user may purchase an electronic purse of electronic currency. When the user requests a page of data, the providing site requests a cookie and this cookie is sent with the appropriate number of electronic coins (monetary amount of electronic currency) imbedded in it. The users account is deducted accordingly. A cookie transfer method may be necessary in the absence of the Internet protocol being modified to support such automated transaction payments for data.

One example where this patent would have an immediate application is in the field of Internet Gambling. Internet Gambling is an activity where a resident based in a jurisdiction transacts with a business in another jurisdiction. The jurisdiction in which the business resides collects gambling taxation from the business as a percentage of wagers. There is a demand for a portion of the taxation to be remitted back the jurisdiction of origin so that the jurisdiction of origin may profit from the participation of its citizens in the activity and apply the gambling taxation to community purposes and the treatment of problem gamblers, domestically.

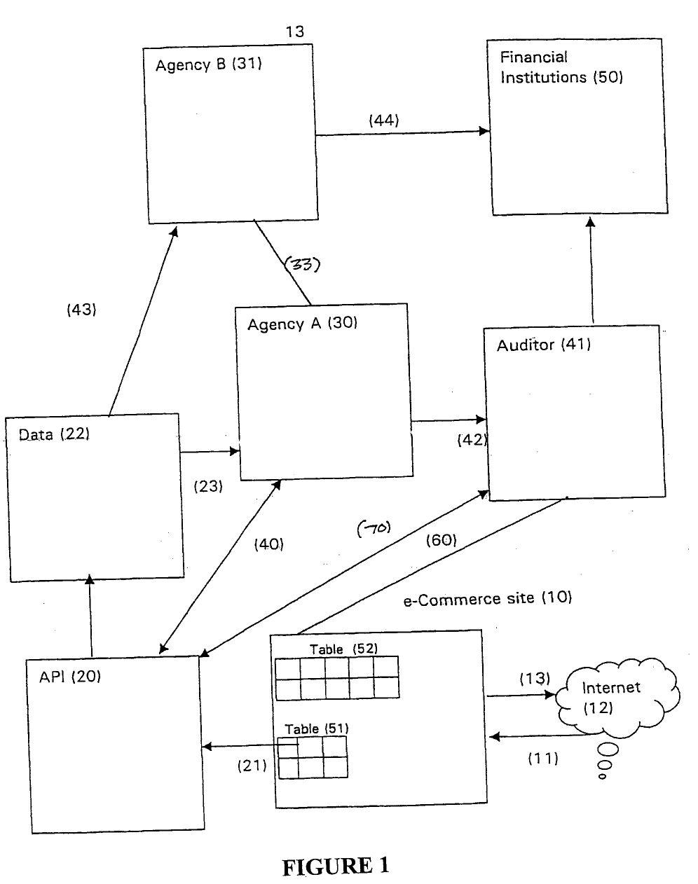

An example of the present invention running over a network is illustrated in FIG. 1. As shown there, an e-commerce site 10 provides content 11 over the Internet 12. Consequently, a user makes a request 13, which results in an e-commerce-transaction. The API 20 of the present invention receives information 21 from the e-commerce site to which it is plugged into or embedded in. In one example, the site 10 compiles a table of data 51, which is accessible by the API 20. The information is processed by the API, for example by compiling a database or table of information 22, which is stored by the API. The data is provided to or monitored by one or more agencies 30, 31. In one particular example, agency A of FIG. 1 might be a private or state government and agency B may be a federal government. In another embodiment, agency A 30 may be a private monitoring organisation and agency B 31 may be a governmental agency, which is supplied with the appropriate data and reports 33 indirectly from agency A 30.

The processing may or may not be distributed between the API and the monitoring system. In one example, the API may just forward the data 22, which it receives from the e-commerce site 10 to the monitoring agency and auditors according to the operational procedures. This data is initially stored in a data table 51 on the e-commerce site 10. In another example, API 20 takes or querries the data from data table 52 from the e-commerce site 10 and processes it to generate the required data table 22, which is forwarded to either monitoring agencies or being accessed by these agencies according to the operational requirements.

Given that the API reports on the data supplied, the integrity of the supplied data is important. Accordingly, an auditor 41 may compare the data inputs or outputs of the API with the origin of the data at the e-commerce site 10 and perhaps also one or more financial institutions or other sources.

It will be appreciated that the integrity of the API as well as the data and other particulars referred to above may be provided to or requested from 40 an external auditor 41. The auditor 41 may in turn supply information 42 with any one of the affiliated agencies 30, 31. The auditor 41 may also compare 70 the data 21 provided by the API 20 with corresponding data 51 from the site 10 (for the purpose of confirming the integrity of data 21) the financial institutions 50 which service the e-commerce site 10 (for the purpose of detecting fraud). In the alternative, an agency, for example agency B may perform this same audit function by comparing data 43 from the API with data 44 from the financial institutions 50.

We claim:

1. An electronic business monitoring application interface, comprising software such as a plug-in or dedicated programme, having software components for performing the steps of:
interfacing with an electronic business system;
obtaining data associated with the operation of the business;
providing a reply to a monitoring system.

2. The electronic business monitoring application interface of claim 1, wherein;
obtaining data comprises interrogating then capturing data from the operation of the business and using the data to compile a database or table or reply.

3. The electronic business monitoring application interface of claim 2, wherein;
the data is processed by the interface before the reply is provided to the monitoring system.

4. The electronic business monitoring application interface of claim 1, having further software components for performing the steps of:
interfacing directly with an auditor so as to provide the auditor with any one of the following kinds of information: some or all data inputs to the reply, the reply, or portions of the reply.

5. An electronic business monitoring system comprising the hardware and software required to perform, in a network, the steps of:
monitoring one or more electronic business monitoring application interfaces by receiving one or more replies from an application interface.

6. The electronic business monitoring system of claim 5, having further software components for performing the steps of:
comparing a reply to a set of rules and then generating a report based on the comparison.

7. The electronic business monitoring system of claim 6, having further software components for performing the steps of:
generating an alert upon detection of an irregularity.

8. The electronic business monitoring system of claim 5, having further software components for performing the steps of:
providing data or reports over the network to affiliate monitoring systems, agencies or government bodies.

9. The electronic business monitoring system of claim 5, having further software components for performing the steps of:
monitoring the integrity of the one or more electronic business monitoring application interfaces.

10. The electronic business monitoring system of claim 5, wherein:
one or more of the electronic business monitoring application interfaces are of the type claimed in any one of claims 1-4.

11. The combination of an electronic business and an electronic business monitoring application interface as claimed in any one of claims 1-4.

12. A method of collecting data about electronic businesses comprising the steps of:
receiving replies from an electronic business monitoring application interface of the type claimed in any one of claims 1-4; and
producing a report or alert based on the replies.

13. The method of collecting data about electronic businesses of claim 12, further comprising the step of:
obtaining information from a financial institution or auditor then comparing that information with one or more replies.

14. The method of collecting data about electronic businesses of claim 12, further comprising the step of:
sharing data with one or more other monitoring agency, organisation or government.

15. The method of collecting data about electronic businesses of claim 12, further comprising the step of:
promulgating or abiding by a set of rules, PKI or CPS which apply to a monitored electronic business monitoring application interface of the type claimed in any one of claims 1-4.

16. The method of collecting data about electronic businesses of claim 12, further comprising the step of:
verifying the currency or integrity of the electronic business monitoring application interface software or any aspect of the data it relies on or produces.

17. The method of collecting data about electronic businesses of claim 12, further comprising the step of:
initiating, in respect of a monitored electronic business, an electronic funds transfer for remittance or other purposes.
